(19) United States
(12) Patent Application Publication
(10) Pub. No.: US 2016/0042446 A1
(43) Pub. Date: Feb. 11, 2016

(54) INTELLIGENT AND REAL TIME, LOCATION BASED, AUTOMATED AND INSTANTANEOUS FLUID PRICING MANAGEMENT SYSTEM

(71) Applicants: Sundaresan Chandrasekaran, Schaumburg, IL (US); Sravya Sarvareddy, Schaumburg, IL (US)

(72) Inventors: Sundaresan Chandrasekaran, Schaumburg, IL (US); Sravya Sarvareddy, Schaumburg, IL (US)

(21) Appl. No.: 14/813,729

(22) Filed: Jul. 30, 2015

Related U.S. Application Data
(60) Provisional application No. 62/033,744, filed on Aug. 6, 2014.

(51) Int. Cl. G06Q 30/08

(52) U.S. Cl. CPC G06Q 30/08

(57) ABSTRACT

A system for selling a product includes an admin console module that receives, from a seller, a base price and a price range that is lower than the base price of the product, a database in communication with the admin console that stores the base price and the price range, a user interface that receives, from a customer, a bid for purchasing the product, and a fluid pricing module that, in response to the receipt of the bid from the customer, accesses the database and compares the bid to the base price and price range. The fluid pricing module instructs the customer to submit a revised bid when the bid is within the price range.

### CROSS-REFERENCE TO RELATED APPLICATIONS

This application incorporates by reference and claims the benefit of priority to U.S. Provisional Application Patent No. 62/033,744 filed Aug. 6, 2014.

### BACKGROUND OF THE INVENTION

This invention relates to an intelligent and real time, location based, automated and instantaneous fluid pricing management system. More particularly, a system that is instantaneous and transparent in operation towards finalization of the transaction process together with that it is location aware letting customers submit a price range or specific price in real time (by location) for a particular product against the available (regular, full priced, on sale, excess, unclaimed, returned or refurbished) inventory and the system that provides an optimum value for the products to both the customer and the seller.

Online shopping is a form of electronic commerce process where the consumers have the choice to see the goods or look at them and then go directly to buy goods from a seller over the Internet with the help of a web browser. An online shop brings to ones' mind the physical process of buying products from a retailer or shopping center; such process is called business-to-consumer (B2C) online shopping. In the case where a business buys from another business, the process is called business-to-business (B2B) online shopping. Retail sales success is no longer limited to the physical stores sales. This has become evident because of the increase in sales process or activity by the retailers now offering online store interfaces for consumers. With the growth of online shopping, there comes a wealth of new market coverage activities or opportunities for retail stores that can appropriately cater to offshore market demands and service requirements. So the consumers find a product of interest by visiting the website of the retailer directly or by searching among alternative vendors using a shopping search Engine system.

Once a particular product has been found on the website of the seller, most online retailers use a software “shopping cart” to allow the consumer to accumulate multiple items and to adjust such quantities, similar to filling a physical shopping basket in a conventional retail store. A “checkout” process is followed in which payment and delivery information is collected. Some retail stores allow consumers to sign up for a permanent online account so that most of the information only needs to be entered once. The consumer often receives an email confirmation once the transaction is complete. Less sophisticated stores normally rely on consumers to call in or email their orders. Online shopping has become popular because of the convenience it offers. Recently, new ways to save money while shopping online have grown tremendously. Buyers have traditionally shopped through a retailer, filled an online shopping cart and then paid for the goods. Another way is to shop through an online auction site and bid against other buyers for items. Recently, shopping through daily deals or coupon websites has become a very popular option because of the opportunity to get large discounts.

Most systems for processing the sale of products are seller-driven, whereby the retailer or the seller sets a price, and offers the product for sale, and the buyer decides whether or not to accept the seller's offer. But in a buyer driven system, the buyer dictates the terms of the offer and the seller decides whether or not to accept the offer. There are many buyer-seller arrangements in use today. However, almost all such systems are seller-driven in the sense that they focus on the methods and processes available to the seller, allowing sellers to set a price, package the goods, and market them more effectively. Stores, catalogs, telemarketing, auction houses, are all seller-driven commerce systems. The seller's job is to attract buyers to complete a sale.

Priceline.com has a bidding system for the hotel, airline and rental car reservation industry. But this system has various limitations. For example, Priceline.com does not apply to retail goods or products and services, nor does Priceline.com allow customers to enter a price range. Instead, Priceline.com only allows users to enter a specific price. Further, Priceline.com and similar systems are not transparent. In other words, customers cannot bid against a specific seller (e.g., a specific hotel chain, a specific airline carrier, or a specific car rental company), nor do customers have a multi-level bidding capability. Priceline.com also does not allow customers to rebid on the exact same parameters again if their initial bid was unsuccessful. Further more, Priceline.com does not allow customers to reverse a successful bid or transaction. In addition, Priceline.com and similar systems fail to include a mechanism to identify the most valuable customers. Further, Priceline.com fails to offer any subscription capabilities.

Prisminister (www.prisminister.dk) is a Denmark based company that collects a deposit from a user wanting to bid on purchasing a product and the dealer is allowed to make a return offer if the customer's bid is too low. However, Prisminister fails to have real time or location based capabilities, nor any mechanism to identify the most valuable customers.

Nypdigital, an American digital marketing agency, is directed to a website management, SEO, Google AdWords, and social networking service that allows the customer to name their own price. However, Nypdigital fails to apply to retail goods or products. In addition, Nypdigital fails to identify the most valuable customers.

WalMart ran a promotion during 2011 & 2012 holiday season (October to December) where they asked their customers to select from five different options to know what was the best price point for a particular product. Later they put the product at the price point that received the most votes. Here, Wal Mart fails to accept a price range from a customer and to include any mechanism to identify the most valuable customers.

Humblebundle (www.humblebundle.com) includes a name your own price concept for games. However, Humblebundle fails to neither accept the input of a price range, nor does it help the seller identify the most valuable customers.

As a result, there is a need for systems and methods of optimizing the price of various products. Specifically, there is a need for systems and methods which offer transparency in operation and are instantaneous in the transaction decision process, where customers quote a price range or price point against a specific product and use a set of predetermined parameters to extend a personalized sale price for each customer thereby identifying the most valuable customers.

### BRIEF SUMMARY OF THE INVENTION

The present invention discloses systems and methods wherein the sellers, or retailers, become aware of the actual worth or price of the product that a single customer or a majority of the customers attach to the retailers' products during the transaction process.

It is another object of this system to help the sellers, or retailers, to become aware of the actual worth or price of the product which customers attach to the products that are going into “promotions/mark down” phase, “clearance” phase or with returned or refurbished products.

The present system enables sellers or vendors to combat “dynamic pricing” from competition.

The system provides a means for a customer to specify a particular price point or value the customer is willing to pay for the seller's products and to know instantly if the sale is successful at the specified price point.

The system also provides a means for the customers to specify a price range within which they are willing to pay any amount for the seller's product and to know instantly if the sale is successful at any price point within the specified price range.

The system allows customers to resubmit their bid or bid range for the same product any number of times or a pre-set number of times based on predefined business rules until they are successful, without having to change any parameters.

It is yet another object of this system to provide a visual cue to the customers when they submit a price or price range, on the likelihood of their offer to convert to a successful sale for the particular product.

It is yet another object of this system to offer a truly personalized price for each customer against every product that they buy based on various predetermined parameters.

It is yet another object of this system to enable the sellers or retailers to open up a new “sales phase” before a product is sent into the sales/discount, clearance, or liquidation phase.

It is further object of this system to enable the sellers or retailers to benefit from the segment of window shoppers (at the advertised or list price), as they may become willing buyers at price points lower than the list price.

It is further object of this system to enable the sellers to identify their most valuable customers (using the ‘reputation score’ calculated for each customer based on their individual bid activities) who would pay a price above the seller's base price.

It is further object of the system to let customers bid on multiple (similar) products through the Bid List capability/functionality and have the option of the system closing a sale instantaneously against only one of the products added to the bid list.

It is further object of the system to delight the customers who value a product highly (or customers with a good reputation score) by extending them an upgrade (in most cases free or in some cases for a small additional cost) to the next level (or newer version) of the specific product.

It is further object of the system to provide a recommendation to customers on similar products (that have a higher chance of successful sale) based on a set of predetermined parameters.

It is further object of the system to let members who have bought system currency to reverse a set number of successful bid transactions when they bid using the system currency.

Software arrangement for an e-commerce method solution for an intelligent and real time, location based, automated and instantaneous fluid pricing management system comprises a computer software program:
i. for uploading the product catalogue details in the database module and also to rules engine module/means and setting a base price for the product for sale by the admin console module/means and said software configuring a nudge range provision to bargain engine module/means to issue nudge to customers while quoting a price range or a price for product for sale and finally reporting for the seller to track orders and other key performance metrics;
ii. for storing the data entered in the first step (i) by the admin console module/means in the database module and sharing said data entered with rules engine module/means and simultaneously with the analytics engine module/means;
iii. for processing instantaneously the customer's bid across a single or a plurality of bids by the fluid pricing module/means to issue a nudge or recommendation to the customer based on predetermined parameters simultaneously keeping track of customer's membership, reward, and system currency information;
iv. for enabling customer engagement with this system through visual means by the user interface module/means through the said fluid pricing module/means and incorporating in a mobile, web, tablet, or any such widget applications;
v. for keeping track of every bid submitted by a customer and influencing the decision making process by the said fluid pricing module/means along with the reputation score engine module/means;
vi. for analyzing the data stored in the said database module by the analytics engine module/means and simultaneously reporting the activity generated in the fluid pricing module/means by the reporting engine module/means for displaying key performance indicators and generating rich reports in the predetermined format within the admin console module/means.

Software arrangement for an e-commerce method solution for an intelligent and real time, location based, automated and instantaneous fluid pricing management system further comprising of the fluid pricing module/means to include:
a. a bid and bargain engine module/means to do the instantaneous processing of a customer's bid and issue a nudge when the price quoted by the customer is lower than the base price set and within the nudge range;
b. a recommendation engine module/means to do the instantaneous recommending of products based on a customer's submitted price or price range and other predetermined parameters;
c. a membership and rewards module/means to do the storing and managing customers' membership and rewards or incentives details in a transaction;
d. a system currency module/means to do the storing, managing system currency details for a plurality of customers; and
e. a bid list module/means to do the simultaneous processing of a plurality of bids from a single customer.

In one embodiment, the setting of the base price and finalizing the bid price for the product based at the national level is done by the rules engine module/means along with the admin console module/means. In another embodiment, the setting of the base price and finalizing the bid price for the product is location and territory based performed by rules engine module/means along with the admin console module/means in the system.

In a further embodiment, the whole system operation is being carried out and made instantly based on a set of predetermined parameters, such as demand for the product or sales velocity and/or available inventory, offering total transparency in the bidding operation for the customer by letting the customers quote a price range or price point against a specific product. The available inventory could be the one in the seller's online store, physical store and/or warehouse. The true demand for a particular product based on the plurality of bids (successful and unsuccessful) received for a product from different customers may be indicated in the admin console module/means, by the fluid pricing module/means along with the analytics engine module/means and the reporting engine module/means.

In a further embodiment, the best price optimization recommendation for every product uploaded by the vendors may be indicated in the admin console module/means by the fluid pricing module/means along with the analytics engine module/means and the reporting engine module/means. The additional revenue for a particular product uploaded by the vendor may be indicated in the admin console module/means, by the fluid pricing module/means along with the analytics engine module/means and the reporting engine module/means. Further, in an embodiment, achieving the desired results particularly by the bid and bargain engine module/means and the recommendation engine module/means is done within the fluid pricing module/means. The instant decision of the sale bid process is done by the bid and bargain engine module/means and rules engine module/means with/without input from reputation score engine module/means.

Intelligent and real time, location based, automated and instantaneous fluid pricing management software system comprising an admin console module/means for uploading product catalogue details to database module and also to rules engine module/means and then setting a base price for the product for sale and configuring nudge range provision to bargain engine module/means to issue a nudge to customers; and finally reporting for the seller to track orders and other key performance metrics; a database module for the storage of seller input details and the display of the results of the transaction after analysis; a rules engine module/means to influence decision making of the bidding process based on predetermined parameters; a fluid pricing module/means for processing the customer's bid across a single or a plurality of bids and then issuing a nudge or recommendation to the customer based on predetermined parameters and keeping a track of customer's membership, reward and system currency information; a user interface module/means incorporating mobile, web, tablet, widget applications for enabling customer engagement with this system through visual means; a reputation score engine module/means for keeping track of every bid submitted by a customer and for influencing the decision making by the said fluid pricing module/means; an analytics engine module/means for analyzing the data stored in the said database module and the activity generated in the fluid pricing module/means; a reporting engine module/means for displaying key performance indicators and generating rich reports in the predetermined format within the admin console module/means.

In a further embodiment, the rules engine module/means that controls, influences, and drives decision making shifts the base price of products within the set range as necessary based on predetermined parameters such as sales velocity, available inventory and such similar intelligent functionality driven by location and time bound business rules. In a still further embodiment, the rules engine module/means along with the bid and bargain engine module/means and the recommendation engine module/means that controls, influences, and drives decision making is also responsible for: (1) processing the customer's bid across a single or plurality of bids, reversal of bids based on predetermined criteria such as bid being placed using system currency, availability of bid reversal trials for the customer, and the reversal time window not having expired; and/or (2) controlling the issuance of a nudge to the customer if the submitted bid is within the set nudge range otherwise the fluid pricing module/means will recommend suitable products to the customer based on set predetermined parameters.

In a further embodiment, the bid and bargain engine module/means may take the submitted price or price range from the customer as an input, present the visual cue, and compare against the base price of a product, and make the decision to close a sale successfully if: (a) the submitted price is equal or above the base price; or (b) alternatively any price point within the submitted price range is equal or above the set base price. The visual cue may be presented through a bargain acceptance meter to the customers (so as to make them aware of their offer strength). The bid and bargain engine module/means may provide the subscription capability to members for added visibility into the latest three successful transactions for a specific product. The fluid pricing module/means as a whole through its interfaces may extend an upgrade to the customers (in most cases free or in some cases for a small additional cost) to the next level (or newer version) of the specific product (before or after placing the bid) if the next level of the product also has a good chance of a successful sale at the customer's submitted price point or price range.

In a still further embodiment, the fluid pricing module/means through its bid list module/means controls keeps track of all the items added to the list by a customer and provides the ability to have only one of the transactions closed (decided by the system) across all the submitted bids (price points/ranges) even if multiple submitted bids are successful. The fluid pricing module/means along with the analytics engine module/means and the reporting engine module/means may indicate, in the admin console module/means: (1) the true demand for a particular product based on the plurality of quotes received for the said product by the different customers; (2) the best price optimization recommendation for every product uploaded by the vendors; or (3) the additional revenue for a particular product uploaded by the vendor.

In a still further embodiment, the fluid pricing module/means may achieve the desired results particularly by the bid and bargain engine module/means and the recommendation engine module/means. The instant decision of the sale bid process may be performed by the bid and bargain engine module/means and the rules engine module/means with or without input from reputation score engine module/means. In another embodiment, the base price may be varied dynamically (up or down) on a location by location bases depending on (a) the rate at which products are getting sold at a particular location (sales velocity within a given interval of time) and (b) available inventory remaining to be sold, thereby, resulting in getting the best price for each unit of the seller's product.

Additional objects, advantages and novel features of the invention by way of examples will be set forth in part in the description which follows, and in part will become apparent to those skilled in the art upon examination of the following description and the accompanying drawings or may be learned by production or operation of the examples. The objects and advantages of the various features of the invention may be realized and attained by means of the methodologies, instrumentalities and combinations.

### BRIEF DESCRIPTION OF THE DRAWINGS

The invention will become more clearly understood from the following description in connection with the accompanying drawings. The drawing/figures depict one or more implementations in accordance with the present invention, by way of example only, and not by way of limitations. In the figures, like reference numerals refer to or designate the same or similar elements or components.

FIG. 1 shows a block diagram of an exemplary system in which a representative embodiment of the present invention may be practiced.

FIG. 2 is a block diagram of the intelligent and real time, location based, automated and instantaneous fluid pricing management system.

FIG. 3 is a flow diagram for the process when a customer enters a price range or specific price point for a selected product that he/she wants to buy.

FIG. 4 is a flow diagram for the process where a customer uses the system currency to submit a bid for a price range or price point and pay for the transaction.

FIG. 5 is a flow diagram for the process where a customer reverses a successful transaction as he/she used system currency to pay for the transaction and has the eligibility to reverse a transaction.

FIG. 6 is a flow diagram for the process when a customer adds multiple (similar) products to the bid list and wants the sale to be closed on only one of the items even if multiple bids are successful.

FIG. 7 is a flow diagram for the process when the system recommends similar products (at lower price points) that have a better chance of a successful sale based on the customer's submitted price point or price range.

FIG. 8 is a flow diagram for the process when the system suggests an (free) upgrade to the next level (or newer version) of a product based on the customer's submitted price point or price range and the customer's Reputation Score above a certain threshold.

### DETAILED DESCRIPTION OF THE INVENTION

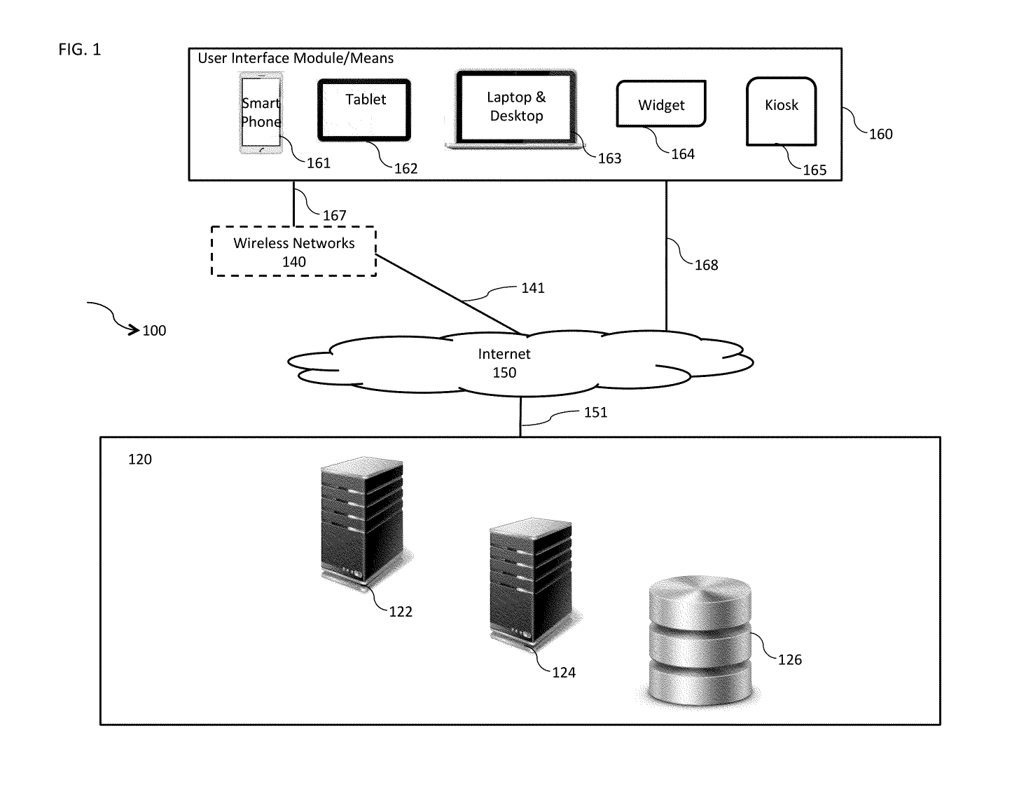

The terms “exemplary” or “example” as utilized herein, means serving as a non-limiting example, instance or illustration. As shown in FIG. 1 the system 100 includes an e-commerce system 120 comprising of one or more database servers 126, one or more application servers 124 and one or more web servers 122. The internal components of the e-commerce system 120 may be inter-connected and externally connected to the internet 150, either singly or as a group through a wireless or wired data communication link 151. FIG. 1 also illustrates a variety of user interface module/means 160, for example, handheld electronic devices like smart phones 161, tablet computers 162, laptop and desktop computers 163, software widgets 164, and stand alone kiosks 165. The variety of user interface devices collectively referred to as user interface module/means 160 can individually access the e-commerce system 120 through the Internet 150 directly using connection links 168, 151 or through wireless networks 140 (for example, data networks of telephone carrier services) using a connection link 167 that connects to the internet 150 through a connection link 141. In accordance with the representative embodiment of the present invention, the elements of the e-commerce system 120 may include suitable software, hardware, suitable logic of an application and/or software application that enables the functionality of the intelligent and real time, location based, automated and instantaneous fluid pricing management system 200.

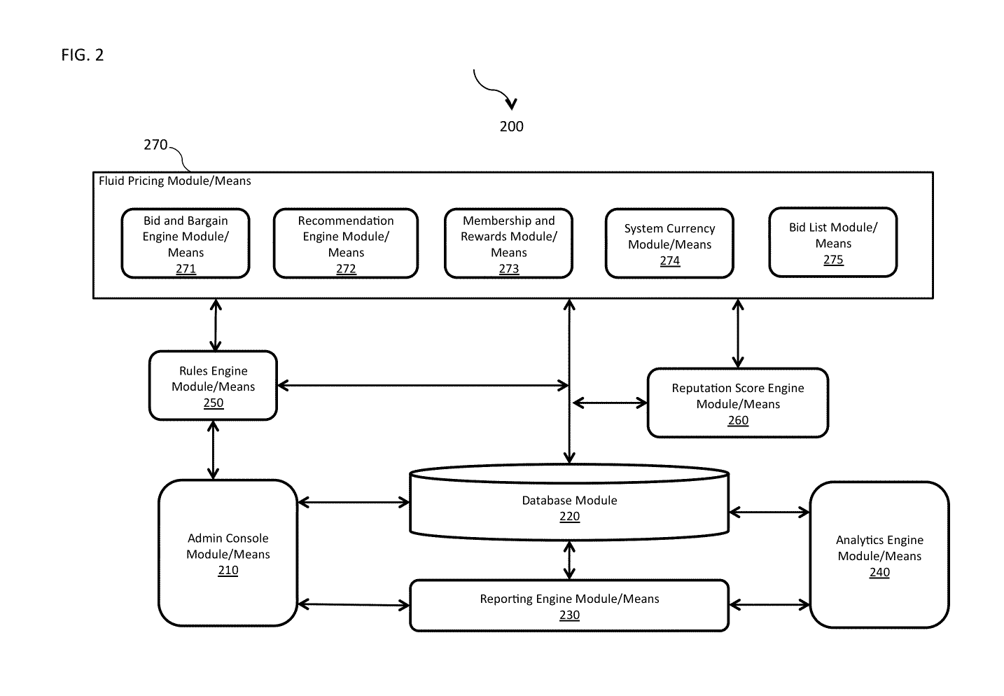

FIG. 2 is a block diagram showing the architecture of intelligent and real time, location based, automated and instantaneous fluid pricing management system 200. The administrative (admin) console module/means 210 first enables the seller to upload product catalog, product name, details, images, inventory details, list price, shipping and other relevant details in the database module 220. Then the admin console module/means 210 enables the sellers to set the base price for products and/or categories of products at a national level and/or by location. It also enables the sellers to configure the nudge range for the bargain engine module/means 271 (within which it will issue a nudge). The said bid and bargain engine module/means 271 is housed in the fluid pricing module/means 270 and also provides the capability to configure a range for shifting the base price based on predetermined parameters. The predetermined parameters could be demand for the product, sales velocity, and/or available inventory. The available inventory could be in the seller's online store, physical store, and/or warehouse.

As shown in FIG. 2, the admin console module/means 210 is connected to the database module 220 for storing all the details input by the sellers such as the product catalog, the base price, the nudge range and the like. The admin console module/means 210 is also connected to the rules engine module/means 250 to set up any specific business rules as per the needs of each individual seller. The admin console module/means 210 also contains a reporting dashboard allowing the seller to track orders and other key performance metrics. The admin console module/means 210 is further connected to reporting engine module/means 230, which is connected to and powered by the analytics engine module/means 240 to track orders, to create reports for key performance metrics, and other similar administrative, operations and/or success criteria.

As shown in FIG. 2, the database module 220 is connected to the said admin consol module/means 210 and stores all the seller input information. It is also connected to the rules engine module/means 250 for storing the business rules entered into the rules engine module/means 250 through the admin console module/means. The database module 220 is further connected with the fluid pricing module/means 270 and reputation score engine module/means 260 for storing customer engagement activity with the system. The said database module 220 is simultaneously connected to analytics engine module/means 240 and reporting engine module/means 230 for data analysis and reporting.

As indicated in FIG. 2, the rules engine module/means 250 controls, influences, and drives decision making for shifting the base price of products within the set range based on predetermined parameters such as sales velocity, available inventory and such similar intelligent functionality driven by location and time bound business rules. It is connected to the database module 220, fluid pricing module/means 270 and the admin console module/means 210.

As shown in FIG. 2, fluid pricing module/means 270 is severally connected to admin console module/means 210 through rules engine module/means 250 and simultaneously connected to database module 220 and reputation score engine module/means 260. It is responsible for processing the customer's bid across a single or plurality of bids, reversal of bids based on pre determined criteria such as bid being placed using system currency, availability of bid reversal trials for the customer and the reversal time window not having expired. It also controls the issuance of a nudge to the customer if the submitted bid is within the set nudge range otherwise the fluid pricing module/means 270 will recommend suitable products to the customer based on set predetermined parameters. The fluid pricing module/means 270 also keeps track of customer's membership, reward and system currency information. The fluid pricing module/means 270 consists of five different module/means: the bid and bargain engine module/means 271, the recommendation engine module/means 272, the bid list module/means 275, the membership and rewards module/means 273, and the system currency module/means 274. These modules are interconnected within the fluid pricing module/means 270.

As shown in FIG. 2, bid and bargain engine module/means 271 receives the submitted price or price range from the customer as an input, presents the visual cue, compares the submitted price or price range with the base price of a product, and makes the decision instantaneously to close a sale transaction successfully if:
a) The submitted price is above or equal to the base price;
b) Alternatively any price point within the submitted price range is above or equal to the base price.

As shown in FIG. 2, the bid and bargain engine module/means 271 also compares the customer submitted bid, which may be a specific price point or a bid range of price points, to the set nudge range and issues a nudge if the customer's submitted price is within the nudge range or price range overlaps fully or partially with the nudge range. It also provides the subscription capability to members for added visibility into the latest set number of successful transactions for a specific product.

As further shown in FIG. 2, the recommendation engine module/means 272 provides a recommendation for similar products (that have a higher chance of successful sale) based on a customer's submitted price or price range and other factors like: customer's reputation score, recommended product's sales velocity, recommended product's inventory level and the like. It also extends an upgrade to the customers (in most cases free or in some cases for a small additional cost) to the next level (or newer version) of the specific product (before or after placing the bid) if the next level of the product also has a good chance of a successful sale at the customer's submitted price point or price range.

The bid list module/means 275 controls and keeps track of all the items added to the list by a customer and provides the ability to have only one of the transactions closed (decided by the system) across all the submitted bids (price points/ranges) even if multiple submitted bids are successful.

The membership and rewards module/means 273 provides rewards or incentives to customers based on each and every transaction activity. It also keeps track of membership details for the customers. The system currency module/means 274 provides the functionality for customers to reverse up to a set number of successful bids and also to buy more system currency to get additional reversible bid trials.

The reputation score engine module/means 260 is connected to database module 220 and fluid pricing module/means 270 for keeping track of every bid submitted by a customer and for influencing the decision making by the fluid pricing module/means 270.

The analytics engine module/means 240 is connected to database module 220 and reporting engine module/means 230 for analyzing the data stored in the said database module 220 and the activity generated in the fluid pricing module/means 270. The analytics engine module/means 240 and reporting engine module/means 230 provide the capability to track both seller and buyer activity by location and time period across single and multiple vendors/sellers.

The reporting engine module/means 230 is connected to analytics engine module/means 240, admin console module/means 210 and the said database module 220 for displaying Key Performance Indicators and generating rich reports in the predetermined format within the admin console module/means 210.

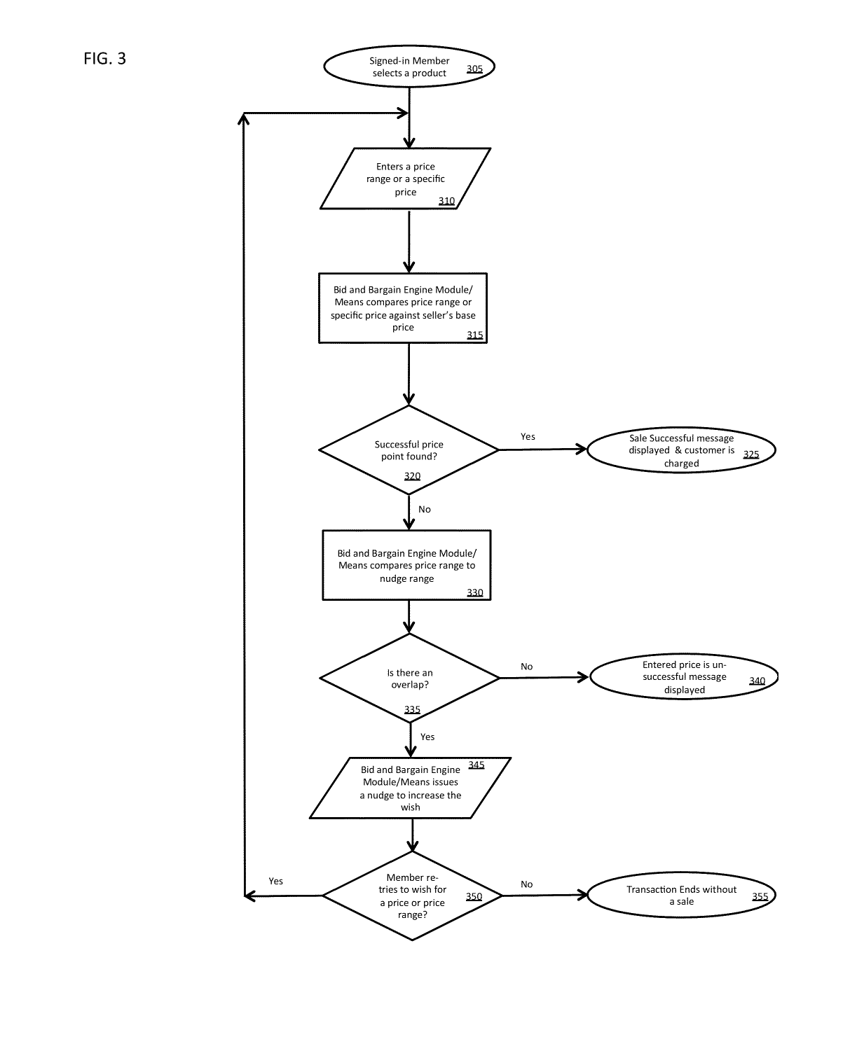

FIG. 3 shows the flow diagram for the process when a customer enters a price range or specific price point for a selected product that he/she wants to buy through the user interface module/means 160 indicated in FIG. 1. The process starts in step 305 when a signed-in member selects a product and enters a price range or specific price as indicated in step 310. Following this, the bid and bargain engine module/means 271 compares price range or specific price against seller's base price in step 315. As indicated in the next subsequent step 320, the bid and bargain engine module/means 271 checks if a successful price point is found or not. If a successful price point is found then the member's payment method is charged and a sale successful message is displayed as shown in step 325. If in step 320, no successful price point is found, then the bid and bargain engine module/means 271 compares price range to nudge range as indicated in step 330 to check if there is an overlap as shown in step 335. If no overlap is found, then the system displays a message saying the entered price is un-successful in step 340. If an overlap is found, then the bid and bargain engine module/means 271 issues a nudge to the member to increase the bid as shown in step 345. At this point, the member can submit a revised bid for a price point or price range as shown in step 350. If the member opts not to then the transaction ends without a sale in step 355, else the member is taken back to the step 310, where they can enter a price range or a specific price for the selected product.

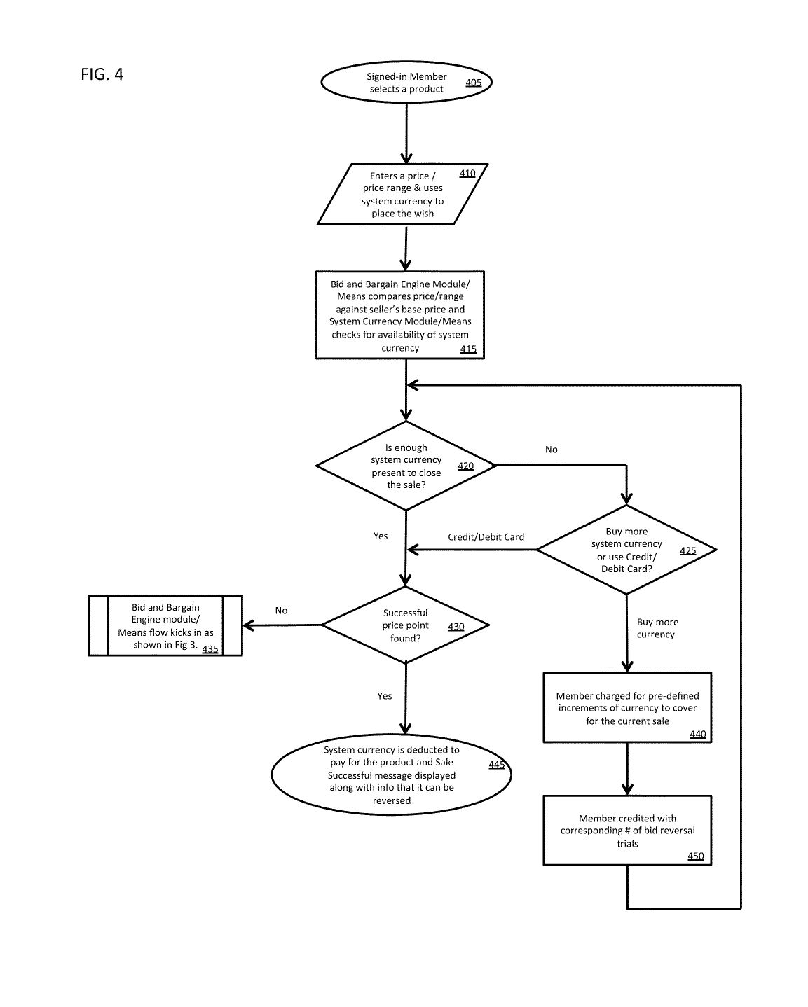

FIG. 4 shows the flow diagram for the process where a customer uses the system currency to bid for a price range or price point and pay for the transaction. The process starts in step 405 when a signed-in member selects a product and enters a price range or specific price as indicated in step 410. Following this, the bid and bargain engine module/means 271 compares price range or specific price against the seller's base price and the system currency module/means 274 checks for availability of system currency in step 415. In the next step 420, if enough system currency is available to close the sale and as indicated in the step 430, the bid and bargain engine module/means 271 checks if a successful price point is found or not. If a successful price point is found then the member's system currency is deducted for the appropriate bid price amount and a sale successful message is displayed along with info that the transaction can be reversed as shown in step 325. If in step 430, no successful price point is found, then, as shown in step 435, the bid and bargain engine module/means 271 flow kicks in as outlined in FIG. 3, i.e., compares the bid price and/or the price range to the nudge range. If in step 420, not enough system currency is found in the member's account, then the member is offered to buy more system currency or use Credit/Debit Card for the transaction as shown in step 425. If the member opts to buy more system currency, then member is charged for pre-defined increments of currency to cover for the current sale as shown in step 440 and is credited with corresponding number of bid reversal trials as shown in step 450 and the flow goes back into step 420 and continues further from there. If in step 425, the member opts to pay using a credit or debit card for the transaction, then the flow leads into step 430 but without the option to reverse the transaction if it were to be successful.

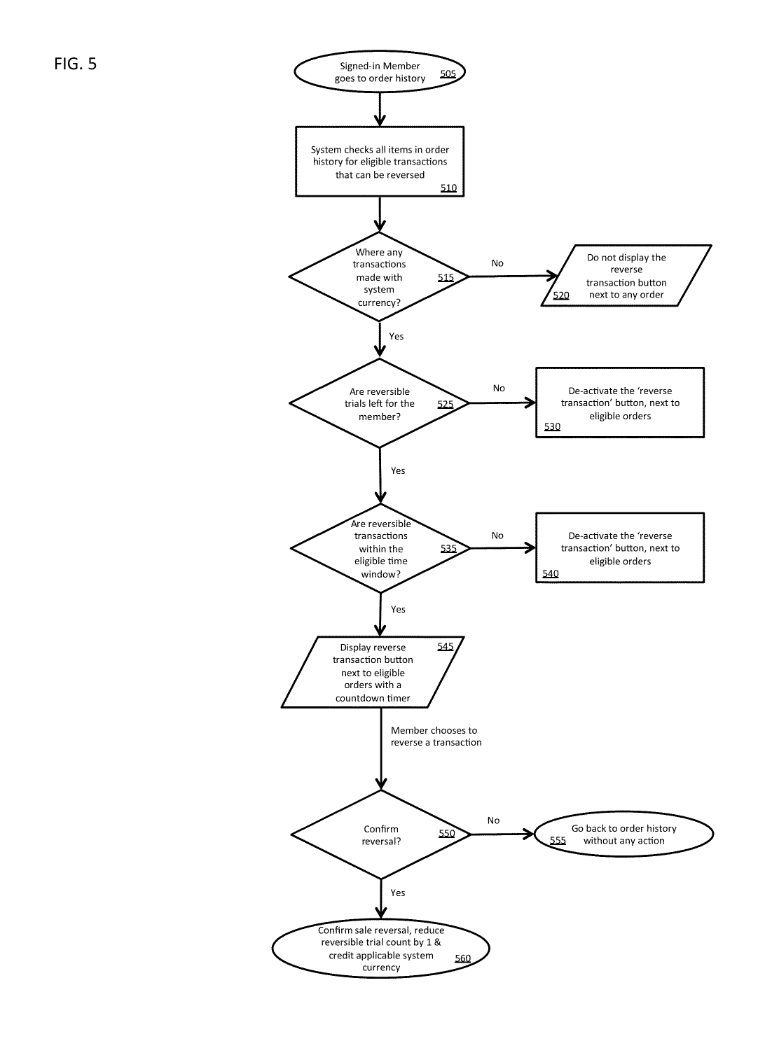

FIG. 5 shows flow diagram for the process where a customer reverses a successful transaction as he/she used system currency to pay for the transaction and has the eligibility to reverse a transaction. The process starts in step 505 when a signed-in member goes to order history. As shown in step 510, the system checks all items in order history for eligible transactions that can be reversed. If there were no transactions found that were made with system currency in step 515, then the system does not display a reverse transaction button next to any order as shown in step 520. If transactions are found in step 515, then it checks if any reversible trials are left for the member in step 525. If all reversible trials have been exhausted, then the system de-activates the ‘reverse transaction’ button, next to eligible orders as indicated in step 530. If the member has reversible trials remaining, then in step 535, the system checks if the reversible transactions are within the eligible time window. If the eligible time window has elapsed, then the system deactivates the ‘reverse transaction’ button next to eligible orders as indicated in step 540. If the eligible time window is still active, then the system displays reverse transaction button next to eligible orders with a countdown timer indicating when the eligibility to reverse the transaction would expire as shown in 545. When a member chooses to reverse a transaction, the system prompts for a confirmation as shown in step 550 and on selection of no, the system takes the member back to order history screen without any action as shown in step 555. On selection of yes in step 550, in the subsequent step 560, the sale reversal is confirmed, the available reversible trial counts is decremented by one, and the applicable system currency is credited back to the member's account and the process ends.

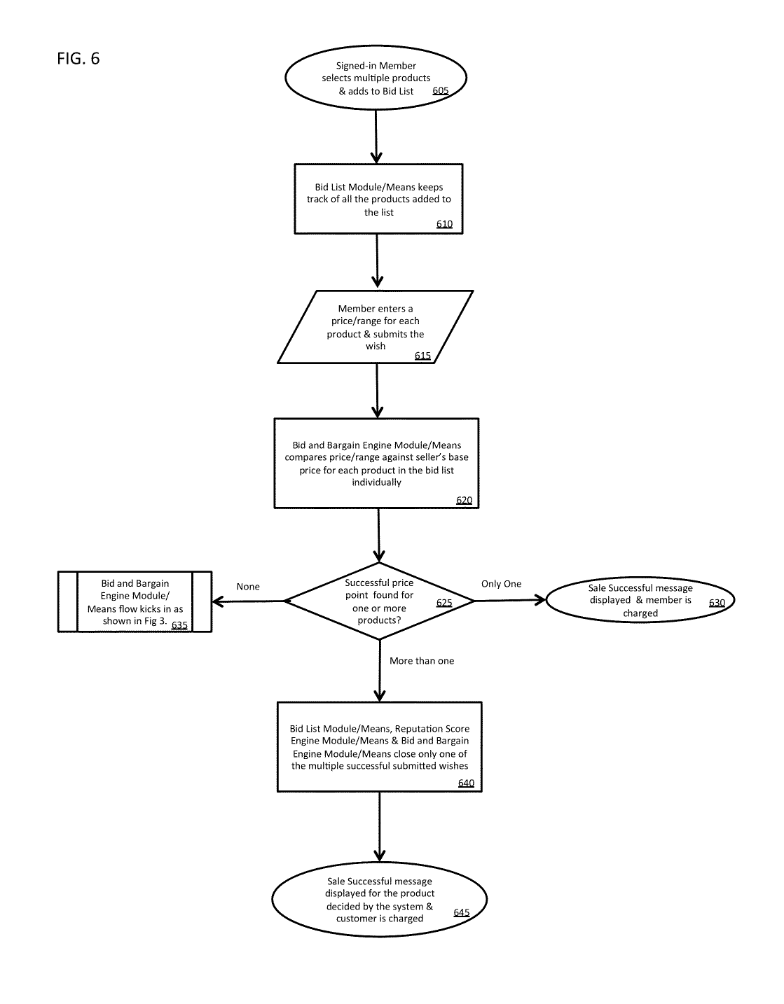

FIG. 6 shows the flow diagram for the process when a customer adds multiple (similar) products to the bid list and wants the sale to be closed on only one of the items even if multiple bids are successful. The process starts in step 605 when a signed-in member selects multiple products and adds them to the bid list. As indicated in step 610, the bid list module/means 275 keeps track of all the products added to the list. In the next step 615, the member enters a price/range for each product and submits the bid. In the subsequent step 620, the bid and bargain engine module/means 271 compares the price/range against the seller's base price for each product in the bid list individually and in the next step 625, checks if successful price point is found for one or more products. If the bid price for none of the products is successful, then as shown in step 635, the bid and bargain engine module/means 271 flow kicks in as detailed in FIG. 3. If the bid price for only one of the products is successful, then sale successful message is displayed and the member is charged as shown in step 630. If the bid price for more than one of the products is successful, then in step 640, the bid list module/means 275, the reputation score engine module/means 260, the bid and bargain engine module/means 271 close only one of the multiple successful submitted bids. In the next step 645, sale successful message is displayed for the product decided by the system and the customer is charged with which the process ends.

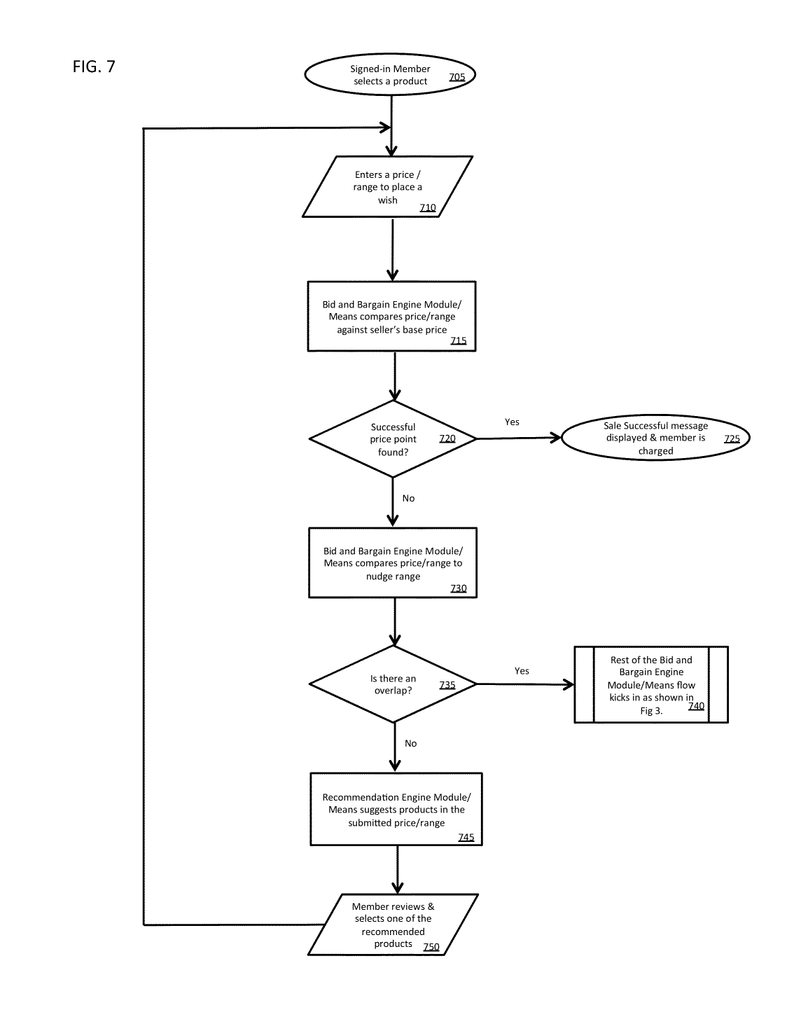

FIG. 7 shows the flow diagram for the process when the system recommends similar products (at lower price points) that have a better chance of a successful sale based on the customer's submitted price point or price range. The process starts in step 705 when a signed-in member selects a product and enters a price range or specific price as indicated in step 710. Following this, the bid and bargain engine module/means 271 compares the price range or specific price against the seller's base price in step 715. As indicated in the next subsequent step 720, the bid and bargain engine module/means 271 checks if a successful price point is found or not. If a successful price point is found, then the member's payment method is charged and a sale successful message is displayed as shown in step 725. If in step 720, no successful price point is found, then the bid and bargain engine module/means 271 compares the price range to the nudge range as indicated in step 730 to determine if there is an overlap as shown in step 735. If an overlap is found, then as shown in step 740, the bid and bargain engine module/means 271 flow kicks in as outlined in FIG. 3. If in step 735, no overlap is found, then the recommendation engine module/means 272 suggests products in the submitted price/range to the member as shown in step 745. In the next step 750, the member reviews and selects one of the recommended products and is taken back to step 710 where the member can either change the bid price/range or leave it at the earlier price point or price range.

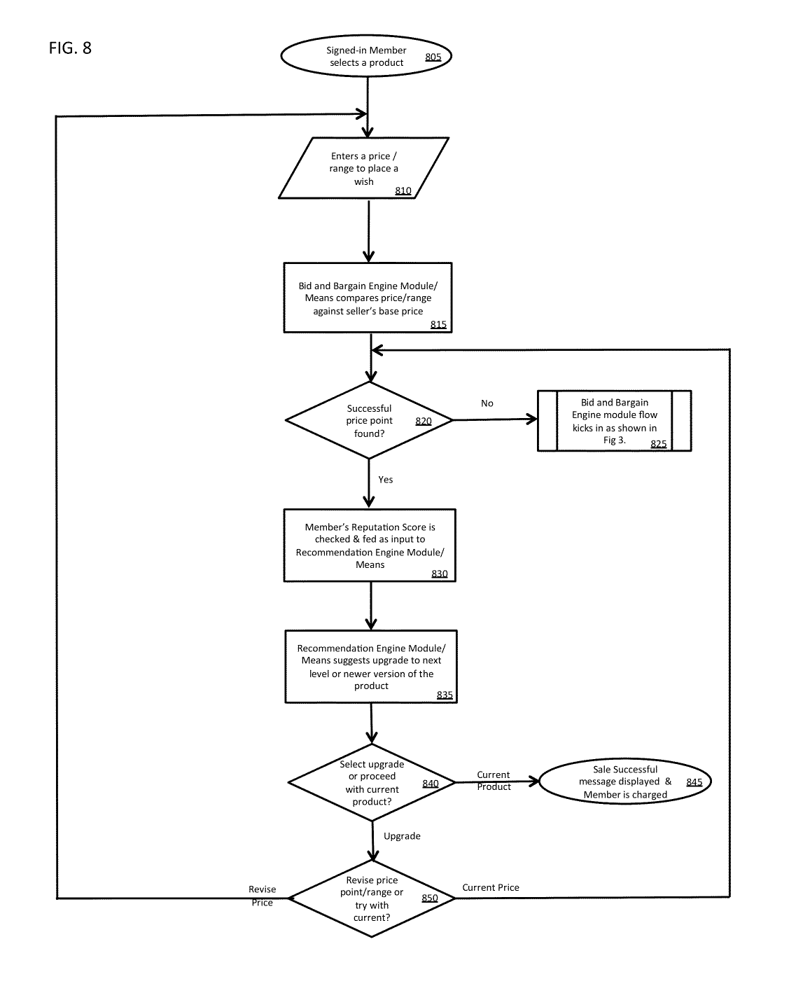

FIG. 8 shows the flow diagram for the process when the system suggests an (possibly free) upgrade to the next level (or newer version) of a product based on the customer's submitted price point or price range and the customer's reputation score being above a certain threshold. The process starts in step 805 when a signed-in member selects a product and enters a price range or specific price as indicated in step 810. Following this, the bid and bargain engine module/means 271 compares the price range or the specific price against the seller's base price in step 815. As indicated in the next subsequent step 820, the bid and bargain engine module/means 271 determines if a successful price point is found or not. If no successful price point is found, then as shown in step 825, the bid and bargain engine module/means 271 flow kicks in as detailed in FIG. 3. If a successful price point is found, then in the next step 830 the member's reputation score is checked and fed as input to the recommendation engine module/means 272. In the next subsequent step 835, the recommendation engine module/means 272 suggests upgrade to next level or newer version of the product. In step 840, the member has the option to select upgrade or proceed with the current product. If the member selects the current product, a sale successful message displayed is displayed and the member's payment method is charged as indicated in step 845. If in step 840, the member chooses to upgrade, then as shown in step 850, the member is presented with an option to either revise the price point or the price range or try with the current price. If current price is chosen, the flow goes back into step 820. If in step 850, the member chooses to revise the bid price, then the flow goes back into step 810.

The vendor/seller has regular, new inventory or excess inventory, and returned or refurbished inventory. The seller uses the admin console module/means 210 to set up a base price (say, $60) for a product to be sold. The seller also configures the nudge range (say $50-$60). On the website or mobile app the customer gets a message saying, “Submit a price for this product”—original list price is $100. The system provides an anchor point for the customers by showing the list price of product (in certain cases, the list price may not be shown), where a customer can bid his/her price. A customer, who values this product very highly, may place a bid for $80 (provided he/she is unaware of any other promotional prices for the product elsewhere on the internet at $75). The system accepts the bid instantaneously and closes the sale in real time.

Another customer, who values the product moderately and checks the price of the product at a different place to be at $75, may place a bid for $70. The system accepts the bid instantaneously and closes the sale again in real time.

Yet another customer, who values the product low, may place the bid at $60. The system accepts the bid instantaneously and closes the sale again in real time.

Yet another customer who values this product very low may bid at $51. At this time the bid and bargain engine 271 will kick in and the system will instantaneously suggest in real time to this customer to increase his/her bid by at least a set percentage (or by at least a set dollar amount), dependent on or driven by the customer's reputation score, so that the bid will be acceptable to the seller—this is done to bring the customer's bid up to at least $60 in this example.

In each of the these above mentioned cases, along with submitting a bid, the customer has to provide payment details (if not already saved in the system) in order for the system to process the bid instantaneously in real time and provide a result: (a) success—the bid was accepted and sale was made in which case, the customer gets charged or (b) the bid was not acceptable to the seller in which case the bid and bargain engine 271 kicks in (if customer's submitted bid falls within the nudge range) and the customer does not get charged.

The system provides a visual cue in the form of a bargain acceptance meter for the customer to understand if his/her offer would convert into a sale. Also during the entire process, the reputation score engine module/means 260 may monitor the customer's bid activities to determine a reputation score for the customer.

### Reputation Score Engine Module/Means 260 Workings

The invention will become more clearly understood from the following description of how the reputation score engine module/means 260 works. The description depicts one or more implementations in accordance with the present invention, by way of example only, and not by way of limitations.

The reputation score engine module/means 260 keeps track of every attempt from a customer to submit price or price range to buy a product.

Every attempt by the customer to get a successful sale carries a weight in calculating their reputation score.

The first attempt carries a fixed weight in order to accommodate for a customer's inability to estimate a proper discounted value (price point or price range) for a product at the onset (very first interaction with the fluid pricing module for that specific product).

If the first attempt is successful in closing the sale then it is assigned 100% weight.

The second attempt carries the next highest weight (in case of three or more attempts to get a successful sale).

In every attempt, the bid's positive distance (when submitted price is above the base price) or negative distance (when the submitted price is below the base price) is multiplied with the attempt's weight.

A cumulative total is calculated across the weighted bid distances for every attempt.

The cumulative total is normalized on a scale of −100 to +100 (the reputation score range).

The closer a customer's reputation score is to +100, the more fair player the customer is and more valuable the customer is to the seller.

The reputation score engine module/means 260 keeps track of time separated bid activities of a customer on the same product and treats it as a subsequent attempt at the product and not as the first attempt (or a fresh start). So after three unsuccessful attempts a customer could close the application or widget and come back to it after a few hours or days and the subsequent attempt at the same product would be treated as the fourth attempt (and not as the first attempt) at the product to assign weight.

Each customer will carry multiple reputation score:
a. Overall Reputation Score
b. Reputation Score tied to each brand
c. Seller based Reputation Score
d. Type of Product (Men, women, home etc.) based
e. Other criteria
   The Unique Features that Make this System an Invention

The system enables the seller to get the appropriate or best price point or a value (either directly or within a price range) for his/her products, which the buyer is willing to pay. This system has not been prevalent anywhere or seen in the retail industry.

The seller can set a “base price” (lowest price at which he/she would sell the product) and hence guaranteeing a “no loss” situation for the seller.

The customer gets the freedom to indicate a price or a price range (if the customer cannot decide on a single price point for the product) that is in line with the value he/she attaches to the product and instantly know if the sale was successful or not.

If the price (or price range) submitted by the customer happens to be slightly lower (within certain range, called the nudge range, configurable by the seller) than the base price or a certain portion of the price range submitted by the customer overlaps with the nudge range, the system will nudge the customer instantaneously in real time to increase his/her bid by a specific amount (depending on the customer's reputation score) or using a generic message, so that the transaction can be closed if it becomes mutually acceptable to both the buyer and the seller.

The system helps vendors/sellers combat “dynamic pricing” from competition as there is no way of identifying a vendor's lowest acceptable price point (base price) or a value for a product (as the base price is not published to the customers).

The system can vary the “base price” dynamically (up or down) on a location by location bases depending on (a) the rate at which products are getting sold at a particular location (sales velocity within a given interval of time) and (b) available inventory remaining to be sold, thereby, resulting in getting the best price for each unit of the seller's product.

The system provides a way for the sellers/merchants to gauge the true value, customers attach to a product in a specific location and at a given period in time. This system will act as a goldmine of data for sellers looking to optimize their pricing (original, sale or clearance) on products.

There is no potential downside (in terms of revenue or branding) to using the system. It only has an upside for the seller.

This system takes out the “buyer's remorse (sense of regret after having made a purchase usually at a price point higher than the value they attach to it)” from the buy process. This may reduce the product returns rate.

This system tracks the transaction history of each individual buyer and builds a “reputation score” of “fair pay” and uses this score to assist the seller in determining what future offers to extend to this particular customer.
a. Scenario 1: let's say a customer always values products from a seller at a higher price point or a value than the lowest acceptable price tag the seller would have placed on the product—then the seller can reward or incentivize this customer to come back and shop frequently.
b. Scenario 2: if a member low-balls the system in one of the attempts but then appropriately adjusts the bid the next time around, with or without a nudge from the system—the “reputation score engine module/means 260” is designed intelligently to provide the benefit of doubt (that the customer may not have realized the true value of the product during his/her bid attempt that one time) and hence not affect the “Reputation Score” adversely.

This system lets the customers submit a price or a price range against a particular product from a particular seller (transparent transaction).

If the same product is available from multiple sellers, the customer can submit their price against multiple sellers in the same transaction (by selecting individual checkboxes). In this situation, the fluid pricing module/means 270 will determine the best outcome based on:
a. The price point or value, where the customer's submitted price is greater than the seller's base price
b. Criteria like ‘free shipping’, vendor or seller's rating
c. Seller's distance from the customer—if it determines the shipping price or time.
d. Seller with the least pick/pack and ship time (from warehouse), to ensure the customer gets the purchased product sooner.

This system provides a system currency where in, customers can buy the currency which will give them an ability to back out of a set number of transactions (with-in a set window of time) that they make using the system's currency. Beyond the set number of transactions, every new transaction will be binding at the price submitted by the customer. Additionally, the customer can purchase a set amount of system currency at any point of time (soon after exhausting the reversible trials/transactions or otherwise) to get another set number of trials/transactions where they can back out.

Customers can cash out their system currency for a variety of retail gift cards offered by the system—if they do not want to use their reversible bid trials. The reversible trials will deplete with every transaction to cash out the system currency.

If a customer is considering between multiple (similar) products and would be happy with purchasing just one of those products at the individual submitted price point/value, then they can add all those items to the Bid List provided by the system and place individual bids. The bid list module/means 275 will only close one of the transactions based on pre-determined parameters.

This system has a subscription capability where in a member can pay a monthly subscription to get visibility into the price points at which a set number of previous transactions were closed for every product. This visibility into successful transaction price points will be extended in a limited way to incentivize customers to become subscribing members. Detailed Description of the Invention and how it is intended to work:

How it works with a clear example:
1. Vendor/seller has regular, new inventory or excess inventory, and returned or refurbished inventory.
2. Seller uses the admin console to set up a base price. Example: $60 as the base price for product A at a national level. List price (full price when product A was launched) is $100.
3. Seller configures the base price shift range as $50-$70.
4. Lets say, Product A was launched on Jan 1st 2015 at a list price of $100 and sold at that price for 2 months till Feb 28th 2015. Inventory count was 1,000 units at launch and 400 units were sold during Jan & Feb.
5. Product A was put on promotion (25% off) for 1 month from Mar 1st to Mar 31st 2015 at a price of $75. Another 300 units were sold during March.
6. Instead of pushing Product A to clearance (for 1 month) on April 1st at a price point of $60 the seller chooses to put Product A on this platform with the configurations stated in #2 and #3.
7. On the website or mobile app the customer gets a message saying, “Bid your price for this product”—original list price was $100.
8. The system provides an anchor point for the customers by showing the list price of product A where a customer can bid his/her price.
9. Customer X, who values Product A very highly, may bid for a price of $80 (provided he/she was unaware of the promotional price of $75 elsewhere on the internet). The system accepts the bid and closes the sale instantaneously in real time.
10. Customer Y, who values the product moderately and checks the price of the product at a different place to be at $75, may bid for a price of $70. The system accepts the bid and closes the sale again instantaneously in real time.
11. Customer Z, who does not value the product much, may bid for a price of $60. The system accepts the bid and closes the sale again instantaneously in real time.
12. Yet another customer who values it very low may bid for a price of $51. At this time the bid and bargain engine module/means 271 will kick in and the system will suggest in real time to the customer to increase his/her bid price by at least a set percentage (or by at least a set dollar amount or with a generic message) so that the bid price will be acceptable to the seller—this is done to bring the customer's bid price to at least $60.
13. In each of the cases above (#9 to #12), after providing a bid price, the customer has to provide payment details (if not already saved in the system) in order for the system to process the transaction instantly in real time and provide a result:
(a) success—the bid price was accepted and sale was made in which case, the customer gets charged or (b) the bid price was not acceptable to the seller in which case the bid and bargain engine module/means 271 kicks in and the customer does not get charged.
14. The system provides a visual cue in the form of a bargain acceptance meter for the customer to understand if his/her bid price would convert into a sale (indicative image below).

15. If in the first 10 days (by April 10th), 200 units (out of the excess 300) are sold (or based on similar business rules/logic by product category, by seller, by location), then the system will automatically increase the base price based on a predefined cadence (within the base price shift range set in step #3). The system sends notifications to the seller to inform them about these changes.
16. Similarly the system can also lower the base price (within the shift range) if Product A is not selling very well.
17. The seller can make additional profit in #9, #10 & possibly in #12 above by going through this channel instead of or prior to going into the “clearance” channel.
18. The customer is satisfied as she gets to buy the product at a price that is acceptable to her (thereby minimizing the feeling of overpayment or buyer's remorse).
19. “No Loss” condition kicks in #11 as the customer's bid price was $60 and that was equal to the base price selected by the seller. The sale was closed at this price instantaneously in real time, as it was the lowest acceptable price for the seller.

### DETAILED DESCRIPTION OF REPUTATION SCORE CALCULATION

How it works with a clear example (one method of implementation):
1. Every attempt by the customer to get a successful sale carries a weight while calculating their reputation score.
2. The first attempt carries a fixed 10% weight in order to accommodate for a customer's inability to estimate a proper discounted value (price point or range) for a product at the onset (very first interaction with the Bid Engine for the specific product).
3. The second attempt carries the maximum weight of 45%.
4. The 2^{nd}, 3^{rd} & 4^{th} attempts carry a combined weight of approx. 79%.
5. In every attempt, the submitted price's positive distance (when submitted price is above the base price) or negative distance (when the submitted price is below the base price) is multiplied with the attempt's weight.
6. A cumulative total is calculated across the weighted bid distances in every attempt.
7. The cumulative total is normalized on a scale of −100 to +100 (the reputation score range).
8. The closer a customer's reputation score is to +100, the more fair player the customer is and more valuable the customer is to the seller.
9. Each customer will carry multiple reputation scores:
   a. Overall
   b. Brand based
   c. Seller based
   d. Type of Product (Men, women, home etc.) based
   e. Other criteria
10. The Overall Reputation Score will be calculated based on the reputation score across each purchase transaction for the member.

### Illustration Using an Example

1. Let's say the retail price for the product in our illustration is $250
2. Base price for the product set by the seller is $150
3. Nudge Range set by the seller is $120-$150
4. In this example, we are depicting the behavior of 10 different customers, each represented by a scenario number.

| | Weightage scale for each attempt | | | | | | | | | |
|---|---|---|---|---|---|---|---|---|---|---|
| | Scenario 1 | Scenario 2 | Scenario 3 | Scenario 4 | Scenario 5 | Scenario 6 | Scenario 7 | Scenario 8 | Scenario 9 | Scenario 10 |
| Attempt 1 | 100.0000% | 10.0000% | 10.0000% | 10.0000% | 10.0000% | 10.0000% | 10.0000% | 10.0000% | 10.0000% | 10.0000% |
| Attempt 2 | | 90.0000% | 45.0000% | 45.0000% | 45.0000% | 45.0000% | 45.0000% | 45.0000% | 45.0000% | 45.0000% |
| Attempt 3 | | | 45.0000% | 22.5000% | 22.5000% | 22.5000% | 22.5000% | 22.5000% | 22.5000% | 22.5000% |
| Attempt 4 | | | | 22.5000% | 11.2500% | 11.2500% | 11.2500% | 11.2500% | 11.2500% | 11.2500% |
| Attempt 5 | | | | | 11.2500% | 5.6250% | 5.6250% | 5.6250% | 5.6250% | 5.6250% |
| Attempt 6 | | | | | | 5.6250% | 2.8125% | 2.8125% | 2.8125% | 2.8125% |
| Attempt 7 | | | | | | | 2.8125% | 1.4063% | 1.4063% | 1.4063% |
| Attempt 8 | | | | | | | | 1.4063% | 0.7031% | 0.7031% |
| Attempt 9 | | | | | | | | | 0.7031% | 0.3516% |
| Attempt 10 | | | | | | | | | | 0.3516% |

| | Actual Bids across multiple customers - representing 10 scenarios | | | | | | | | | |
|---|---|---|---|---|---|---|---|---|---|---|
| | Scenario 1 | Scenario 2 | Scenario 3 | Scenario 4 | Scenario 5 | Scenario 6 | Scenario 7 | Scenario 8 | Scenario 9 | Scenario 10 |
| Attempt 1 | $160.00 | $110.00 | $125.00 | $105.00 | $145.00 | $100.00 | $149.00 | $145.00 | $25.00 | $1.00 |
| Attempt 2 | | $153.00 | $145.00 | $122.00 | $147.00 | $134.00 | $123.00 | $146.00 | $50.00 | $22.00 |
| Attempt 3 | | | $150.00 | $143.00 | $130.00 | $146.00 | $130.00 | $147.00 | $75.00 | $57.00 |
| Attempt 4 | | | | $152.00 | $148.00 | $115.00 | $127.00 | $148.00 | $85.00 | $120.00 |
| Attempt 5 | | | | | $240.00 | $134.00 | $144.00 | $149.00 | $95.00 | $40.00 |
| Attempt 6 | | | | | | $157.00 | $123.00 | $144.00 | $100.00 | $100.00 |
| Attempt 7 | | | | | | | $148.00 | $149.00 | $125.00 | $149.00 |
| Attempt 8 | | | | | | | | $200.00 | $145.00 | $31.00 |
| Attempt 9 | | | | | | | | | $175.00 | $149.00 |
| Attempt 10 | | | | | | | | | | $240.00 |

| | Distance of the bid from the base price | | | | | | | | | |
|---|---|---|---|---|---|---|---|---|---|---|
| | Scenario 1 | Scenario 2 | Scenario 3 | Scenario 4 | Scenario 5 | Scenario 6 | Scenario 7 | Scenario 8 | Scenario 9 | Scenario 10 |
| Attempt 1 | $10.00 | $(40.00) | $(25.00) | $(45.00) | $(5.00) | $(50.00) | $(1.00) | $(5.00) | $(125.00) | $(149.00) |
| Attempt 2 | | $3.00 | (5.00) | $(28.00) | $(3.00) | $(16.00) | $(27.00) | $(4.00) | $(100.00) | $(228.00) |
| Attempt 3 | | | $— | $(7.00) | $(20.00) | $(4.00) | $(20.00) | $(3.00) | $(75.00) | $(93.00) |
| Attempt 4 | | | | $2.00 | $(2.00) | $(35.00) | $(23.00) | $(2.00) | $(65.00) | $(30.00) |
| Attempt 5 | | | | | $90.00 | $(16.00) | $(6.00) | $(1.00) | $(55.00) | $(110.00) |
| Attempt 6 | | | | | | $7.00 | $(27.00) | $(6.00) | $(50.00) | $(50.00) |
| Attempt 7 | | | | | | | $(2.00) | $(1.00) | $(25.00) | $(1.00) |
| Attempt 8 | | | | | | | | $50.00 | $(5.00) | $(119.00) |
| Attempt 9 | | | | | | | | | $25.00 | $(1.00) |
| Attempt 10 | | | | | | | | | | $90.00 |

| | Weighted Bid distance from base price | | | | | | | | | |
|---|---|---|---|---|---|---|---|---|---|---|
| | Scenario 1 | Scenario 2 | Scenario 3 | Scenario 4 | Scenario 5 | Scenario 6 | Scenario 7 | Scenario 8 | Scenario 9 | Scenario 10 |
| Attempt 1 | 10.00 | −4.00 | −2.50 | −4.50 | −0.50 | −5.00 | −0.10 | −0.50 | −12.50 | −14.90 |
| Attempt 2 | | 2.70 | −2.25 | −12.60 | −1.35 | −7.20 | −12.15 | −1.80 | −45.00 | −57.60 |
| Attempt 3 | | | 0.00 | −1.58 | −4.50 | −0.90 | −4.50 | −0.68 | −16.88 | −20.93 |
| Attempt 4 | | | | 0.45 | −0.23 | −3.94 | −2.59 | −0.23 | −7.31 | −3.38 |
| Attempt 5 | | | | | 10.13 | −0.90 | −0.34 | −0.06 | −3.09 | −6.19 |
| Attempt 6 | | | | | | 0.39 | −0.76 | −0.17 | −1.41 | −1.41 |
| Attempt 7 | | | | | | | −0.06 | −0.01 | −0.35 | −0.01 |
| Attempt 8 | | | | | | | | 0.70 | −0.04 | −0.84 |
| Attempt 9 | | | | | | | | | 0.18 | 0.00 |
| Attempt 10 | | | | | | | | | | 0.32 |
| Total | 10.00 | −1.30 | −4.75 | −18.23 | 3.55 | −17.54 | −20.49 | −2.74 | −86.40 | −104.93 |
| Normalized | 28.0000 | 18.9600 | 16.2000 | 5.4200 | 22.8400 | 5.9650 | 3.6075 | 17.8113 | −49.1188 | −63.9453 |
| Rep. Score | | | | | | | | | | |

### APPLICATIONS OF THIS INVENTION

This invention will have applications in retail (regular sales, off season, new “old stock”), returned goods (saleable as new or not saleable as new), refurbished goods, holiday packaged deals, secondary sales, fast moving consumer goods (FMCG) for goods close to expiry date, services (massage, spa etc.), potentially restaurants (on low traffic days for yield management) and new “old stock” sales—these are items that were manufactured long ago but were never sold or used.

Although the present invention has been described with respect to a preferred embodiment thereof, those skilled in the art will note that various changes and modifications or substitutions may be made to those embodiments described herein without departing from the spirit and scope of the present invention and without diminishing its attendant advantages. For example, various embodiments of the method and portable electronic device may be provided based on various combinations of the features and functions from the subject matter provided herein. Furthermore, much of the invention and associated advantages disclosed herein can be equally applicable to an environment in which any given offer is submitted to more than one seller.

What is claimed is:

1. A system for selling a product, comprising:
an admin console module that receives, from a seller, a base price and a price range that is lower than the base price of the product;
a database in communication with the admin console that stores the base price and the price range;
a user interface that receives, from a customer, a bid for purchasing the product; and
a fluid pricing module that, in response to the receipt of the bid from the customer, accesses the database and compares the bid to the base price and price range;
wherein the fluid pricing module:
completes a sales transaction between the seller and the customer for the product when the bid is greater than the base price;
instructs the customer to submit a revised bid when the bid is within the price range; and
rejects the sales transaction between the seller and the customer for the product when the bid is less than the price range.

2. The system of claim 1, further comprising a reputation score module in communication with the fluid pricing module that calculates and associates a reputation score with the customer based on one or more bids related to an attempted sale, wherein each bid is weighted such that the sum of the weights amount to 100%, and wherein the reputation score of the customer with respect to the attempted sale is determined by, for each respective bid, multiplying the difference between the respective bid and the base price by the weight of the respective bid to determine a reputation sub-score and then summing each of the reputation sub-scores to calculate the reputation score of the customer with respect to the attempted sale.

3. The system of claim 2, wherein the weight of a subsequent bid is lower than the weight of a previous bid.

4. The system of claim 2, wherein the reputation score module calculates a total reputation score by averaging one or more reputation scores of the customer each related to a unique attempted sale.

5. The system of claim 2, wherein the reputation score module calculates a brand reputation score for the customer by averaging one or more reputation scores related to each attempted sale made by the customer related to the brand.

6. The system of claim 2, wherein the reputation score module calculates a seller reputation score for the customer by averaging one or more reputation scores related to each attempted sale made by the customer related to the seller.

7. The system of claim 2, wherein the reputation score module calculates a product type reputation score for the customer by averaging one or more reputation scores related to each attempted sale made by the customer related to the product type.

8. The system of claim 7, wherein the product type is one of home electronics, women's shoes, and children's toys.

9. The system of claim 2, wherein the fluid pricing module accesses a minimum incentives score provided by the seller and stored in the database and provides an incentive to the customer when the reputation score is greater than the minimum incentives score.

10. The system of claim 1, wherein the fluid pricing module manages a plurality of bids submitted by the customer related to a plurality of products of a common product type, determines if any of the plurality of bids is greater than the respective base price of the respective product, sells only one product of the plurality of products, and cancels all remaining bids.

11. The system of claim 10, wherein the fluid pricing module accepts the lowest bid that is greater than the respective base price of the respective product.

12. The system of claim 1, further comprising a rules engine module in communication with the fluid pricing module, wherein the rules engine module increases the base price of the product as a sales velocity of the product increases.

13. The system of claim 1, further comprising a rules engine module in communication with the fluid pricing module, wherein the rules engine module increases the base price of the product as an inventory of the product decreases.

14. The system of claim 1, further comprising a system currency comprising a notation of value that is unique to the system.

15. The system of claim 1, wherein the bid is a specific price point.

16. The system of claim 1, wherein the bid comprises a bid range of price points, and wherein the fluid pricing module completes a sales transaction between the seller and the customer for the product when any price point within the bid range is greater than the base price.

17. The system of claim 1, wherein the identity of the seller is known to the buyer at the time of bidding.

18. The system of claim 1, wherein the fluid pricing module completes, instructs, and rejects in real time.

19. A method of selling a product, comprising:
receiving a base price and a price range less than the base price from a seller for the product;
receiving a bid for purchasing the product from a customer;
comparing the bid to the base price and price range; and
when the bid is greater than the base price, selling the product to the customer;
when the bid is within the price range, instructing the customer to submit a revised bid; and
when the bid is less than the price range, not selling the product to the customer.

20. The method of claim 19, wherein the bid is a specific price point.

21. The method of claim 19, wherein the bid is a bid range of price points;
wherein the step of comparing comprises comparing the bid range to the base price and price range;
when any price point of the bid range is greater than the base price, selling the product to the customer;
when any price point of the bid range is within the price range, instructing the customer to submit a revised bid; and
when every price point within the bid range is less than the price range, not selling the product to the customer.

22. The method of claim 19, further comprising the step of, when the bid is within the price range, recommending a further product that is similar to the product and has an associated base price that is within the price range.

23. The method of claim 19, further comprising the step of, when the bid is less than the price range, recommending a further product that is similar to the product and has an associated base price that is less than the price range.

24. The method of claim 19, wherein the product has a sales velocity, and wherein the method further comprises the step of recommending a further product that is similar to the product and has an associated sales velocity that is greater than the sales velocity of the product.

25. The method of claim 19, further comprising the steps of:
calculating a reputation score associated with the customer based on one or more bids related to an attempted sale;
setting a minimum upgrade reputation score;
comparing the reputation score of the customer to the minimum upgrade reputation score; and
recommending an upgrade to the customer whose reputation score is greater than the minimum upgrade reputation score.

26. The method of claim 19, further comprising the step of recommending a further product to the customer based on similarity of the product and the further product and based on the customer's reputation score.

27. Non-transitory computer usable medium comprising:
a computer program configured to cause a process to execute the steps of:
receiving a base price and a price range less than the base price from a seller for a product;
receiving a bid for purchasing the product from a customer;
comparing the bid to the base price and price range; and
when the bid is greater than the base price, selling the product to the customer;
when the bid is within the price range, instructing the customer to submit a revised bid; and
when the bid is less than the price range, not selling the product to the customer.
